(19) United States
(12) Patent Application Publication
(10) Pub. No.: US 2023/0111163 A1
(43) Pub. Date: Apr. 13, 2023

(54) ADULT ESTABLISHMENT RESERVATION SERVICE PROVIDING SYSTEM AND METHOD, AND RECORDING MEDIUM IN WHICH COMPUTER-READABLE PROGRAM FOR EXECUTING METHOD IS RECORDED

(71) Applicant: Geun Young PARK, Seoul (KR)

(72) Inventor: Geun Young PARK, Seoul (KR)

(21) Appl. No.: 17/915,635

(22) PCT Filed: Mar. 25, 2021
(86) PCT No.: PCT/KR2021/003724

§ 371 Date: Sep. 29, 2022

(30) Foreign Application Priority Data
Mar. 31, 2020 (KR) 10-2020-0039203

(51) Int. Cl. G06Q 10/02; G06Q 30/08

(52) U.S. Cl. CPC G06Q 10/02; G06Q 30/08

(57) ABSTRACT

The service manager list providing unit provides a service manager list of adult establishment to the user terminal when receiving an adult establishment select input from the user terminal, the service manager information providing unit provides information of the selected service manager to the user terminal when some of the service managers provided in the service manager list from the user terminal are selected, the table arrangement information providing unit provides table arrangement information of adult establishment to the user terminal when a table reservation request is input from the user terminal, the table price information providing unit provides price information on the selected table to the user terminal when the table is selected by the user terminal, the reservation information providing unit transmits the determined reservation information to the terminal of the service manager when the reservation for the table is determined by the user terminal, and the reservation setting unit sets a reservation for the table when there is an approval input from the service manager terminal.

### TECHNICAL FIELD

The present invention relates to a system and method for providing an online service, and more particularly, to a system and method for providing a reservation service for an adult establishment through a communication network.

### BACKGROUND ART

Recently, with the development of communication technology, reservation culture has become common. Accordingly, in general, in order to enjoy a movie or performance, a seat is reserved in advance by accessing a reservation system provided by a theater or performance hall.

However, this type of reservation may be applied to a simple type of service, such as when a seat arrangement or a service price is already confirmed, but there is a problem in that it is difficult to apply it as it is to various other types of services.

For example, in the case of a nightclub, table arrangement and service prices are variable, and table service may also be provided in various forms by a manager (MD) in charge of the service.

Accordingly, in general, all reservations at nightclubs are conducted using phone calls or messengers (KakaoTalk, WeChat, Line, WhatsApp, etc.) between the customer and the adult establishment MD. However, this type of manual reservation is not only inconvenient in itself, but also has a problem in that large and small disputes may occur in the reservation process.

### DESCRIPTION OF EMBODIMENTS

### Technical Problem

The present invention has been devised to solve the above-mentioned conventional problems, and an object of the present invention is to provide a service system and method that allow more convenient and effective adult establishment reservation.

### Solution to Problem

In order to achieve the above object, an adult establishment reservation service providing system according to the present invention includes a service manager list providing unit, a service manager information providing unit, a table arrangement information providing unit, a table price information providing unit, a reservation information providing unit, and a reservation setting unit.

The service manager list providing unit provides a service manager list of adult establishment to the user terminal when receiving an adult establishment select input from the user terminal, the service manager information providing unit provides information of the selected service manager to the user terminal when some of the service managers provided in the service manager list from the user terminal are selected, the table arrangement information providing unit provides table arrangement information of adult establishment to the user terminal when a table reservation request is input from the user terminal, the table price information providing unit provides price information on the selected table to the user terminal when the table is selected by the user terminal, the reservation information providing unit transmits the determined reservation information to the terminal of the service manager when the reservation for the table is determined by the user terminal, and the reservation setting unit sets a reservation for the table when there is an approval input from the service manager terminal.

According to this configuration, even for an adult establishment such as a nightclub where the price of table arrangement and service is variable, it is possible to easily grasp information such as various current table layouts or table prices of an adult establishment, so that reservations may be made more easily and effectively.

In addition, it is possible to easily identify and select information about a number of service managers of various adult establishments in charge of table service, and by making reservations through public systems rather than through private communications, it is possible to reduce the possibility of disputes as well as the convenience of reservations.

At this time, the table arrangement information providing unit includes an image drawing providing unit that provides an image drawing of an adult establishment in which the table arrangement state is shown to a user terminal, and an activation drawing providing unit that provides a drawing in which some areas are enlarged and a table select function is activated when a partial area of the image drawing is selected from the user terminal, and the image drawing providing unit may provide by displaying the selected table on the image drawing when the table is selected through the activated drawing.

According to this configuration, even when using a mobile terminal with a small screen, it is possible to easily understand the entire table arrangement or reservation status of an adult establishment, and it is possible to prevent touch errors by using the enlarged screen when entering an actual reservation.

In addition, the price information may include preset price information for the table, and may further include a current bid price for the table. According to such a configuration, it is possible to stably provide a table price set in advance according to table arrangement, etc., and in a special situation, it is possible to provide a table price suitable for the situation through an auction.

Also, the price information may further include an immediate winning bid for the table.

At this time, it may further include a table price information storage unit for storing the price information set in advance for the entire adult establishment table. According to such a configuration, it is possible to easily apply a more appropriate table price according to the situation by applying the overall price configuration preset for each situation such as weekdays, weekends, and Christmas.

In addition, it may further include a clearing request transmission unit configured to transmit a table emptying request to a preset table manager terminal when the table emptying request is input from the terminal of the service manager, a reservation-state change request input unit configured to receive a reservation update request for the table from the table manager terminal, and a reservation-state change unit configured to change the reservation status for the table, and display a reservation availability status for the image drawing.

According to this configuration, when the use of the table is finished, it is possible to effectively update the reservation condition for the next use and update the table reservation status.

In addition, tabs performing a table select input function in the activated drawing may be disposed on the image of the table to have the same size as the size of the corresponding table, or may be disposed on the image of the table corresponding to the same size as each other.

In addition, an invention implementing the system in the form of a method and a recording medium in which computer-readable program for executing method is recorded are disclosed together.

### Advantageous Effects of Disclosure

According to the present invention, even for an adult establishment such as a nightclub where the price of table arrangement and service is variable, it is possible to easily grasp information such as various current table layouts or table prices of an adult establishment, so that reservations may be made more easily and effectively.

In addition, it is possible to easily identify and select information about a number of service managers of various adult establishments in charge of table service, and by making reservations through public systems rather than through private communications, it is possible to reduce the possibility of disputes as well as the convenience of reservations.

In addition, even when using a mobile terminal with a small screen, it is possible to easily understand the entire table arrangement or reservation status of an adult establishment, and it is possible to prevent touch errors by using the enlarged screen when entering an actual reservation.

In addition, it is possible to stably provide a table price set in advance according to table arrangement, etc., and in a special situation, it is possible to provide a table price suitable for the situation through an auction.

In addition, by using the overall price configuration preset for each situation such as weekdays, weekends, Christmas, etc., it is possible to easily apply an appropriate table price according to the situation.

In addition, when the use of the table is finished, it is possible to effectively update the reservation condition for the next use and update the table reservation status.

### BRIEF DESCRIPTION OF DRAWINGS

FIG. 1 is a schematic block diagram of an adult establishment reservation service providing system according to an embodiment of the present invention.

FIGS. 2 to 4 are initial screens of a user terminal output for table reservation in the adult establishment reservation service providing system of FIG. 1.

FIGS. 5 to 8 are user terminal output screens for general reservation.

FIGS. 9 and 10 are output screens of the user terminal for auction reservation.

FIGS. 11 to 14 are diagrams illustrating an example of an adult establishment owner uploading a bird's eye view of their adult establishment and arranging a table layout.

FIGS. 15 and 16 are diagrams showing examples of a small bird's eye view and a large bird's eye view, respectively.

FIGS. 17 and 18 are diagrams respectively illustrating different examples in which a table select input function tab is disposed on a table of a bird's eye view.

### BEST MODE

Hereinafter, preferred embodiments of the present invention will be described with reference to the accompanying drawings.

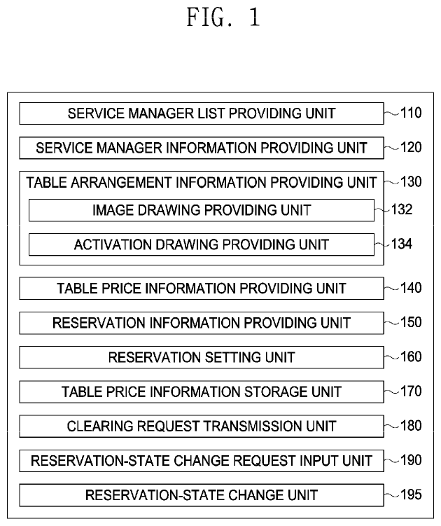

FIG. 1 is a schematic block diagram of an adult establishment reservation service providing system according to an embodiment of the present invention. Referring to FIG. 1, an adult establishment reservation service providing system includes a service manager list providing unit 110, a service manager information providing unit 120, a table arrangement information providing unit 130, a table price information providing unit 140, a reservation information providing unit 150, a reservation setting unit 160, a table price information storage unit 170, a clearing request transmission unit 180, a reservation-state change request input unit 190, and a reservation-state change unit 195, and the table arrangement information providing unit 130 again includes an image drawing providing unit 132, and an activation drawing providing unit 134.

Each of the components of the adult establishment reservation service providing system in FIG. 1 may be implemented only with hardware, but will generally be implemented with hardware and software operating on the hardware.

The service manager list providing unit 110 provides a list of service managers of adult establishment to the user terminal when receiving an adult establishment selection from the user terminal, and the service manager information providing unit 120 provides information of the selected service manager to the user terminal when some of the service managers provided in the service manager list are selected from the user terminal.

According to this configuration, it is possible to easily identify and select information about a number of service managers of various adult establishments in charge of table service, and by making reservations through public systems rather than through private communications, it is possible to reduce the possibility of disputes as well as the convenience of reservations.

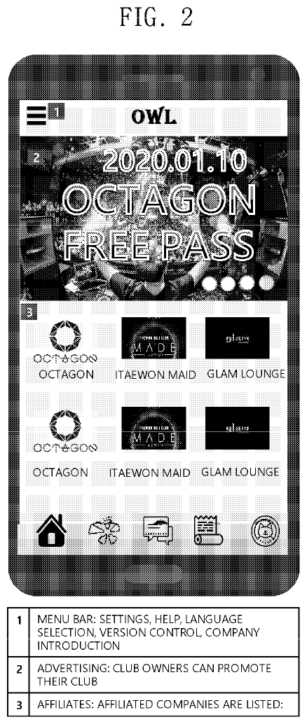

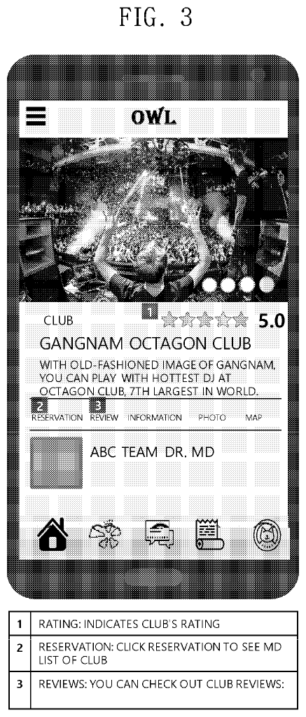

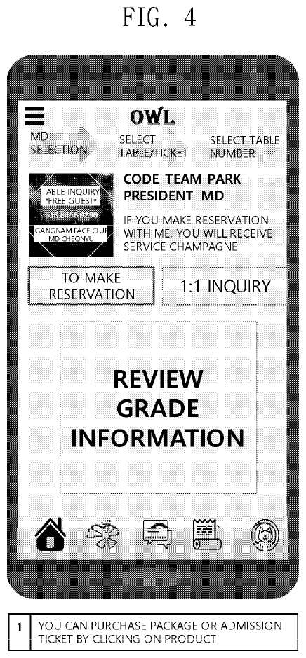

More specifically, the reservation method when selecting an adult establishment is as follows. FIGS. 2 to 4 are initial screens of a user terminal output for table reservation in the adult establishment reservation service providing system of FIG. 1.

When accessing the adult establishment page to promote the service manager's own sales activities, a list of all service managers in the adult establishment appears, and the following procedure is followed to make a reservation.

1) Select adult establishment.

2) A list of service managers (service manager name, service manager rating, number of service manager selections are shown) appears, and click the corresponding service manager.

As for the list sorting method, the basic order should be the advertisement at the top, and after sorting, it is possible to sort by rating, number of selections, and team.

3) The service manager promotion page appears, and it is possible to make a reservation for the service manager in the lower window.

4) If selecting the service manager, it is possible to select table reservation/guest application/paid admission.

In this case, the price information may include price information set in advance for the table, and may further include a current bid price for the table. According to this configuration, it is possible to stably provide a table price set in advance according to table arrangement, etc., and in a special situation, it is possible to provide a table price suitable for the situation through an auction. Also, the price information may further include an immediate winning bid for the table.

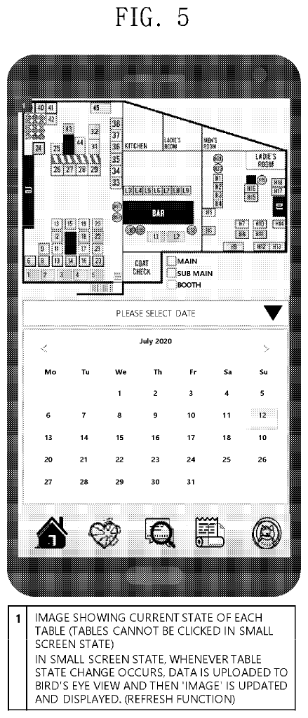

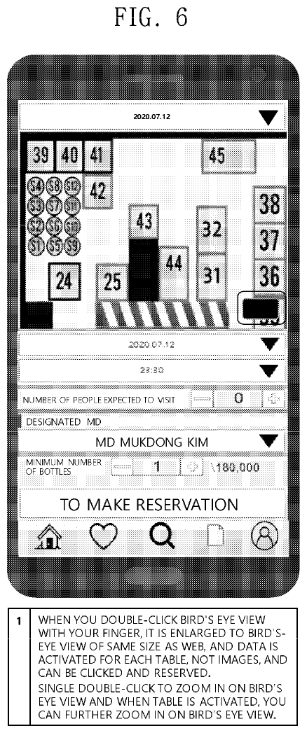

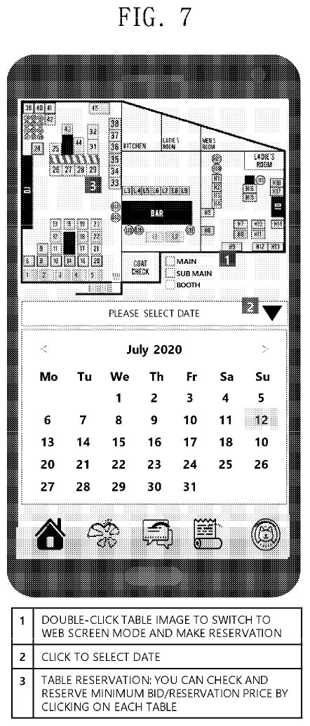

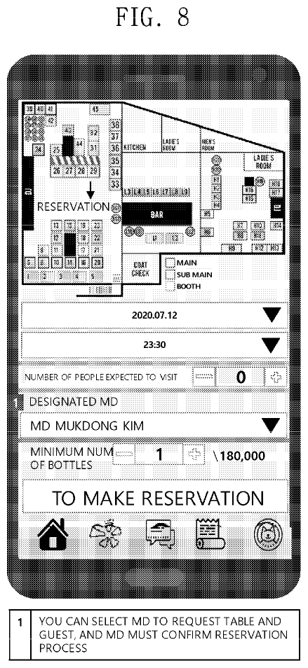

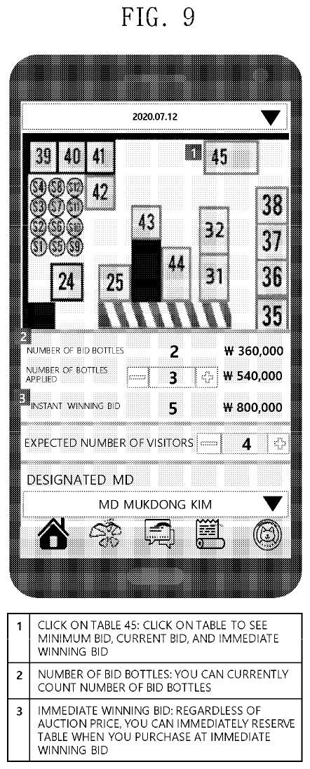

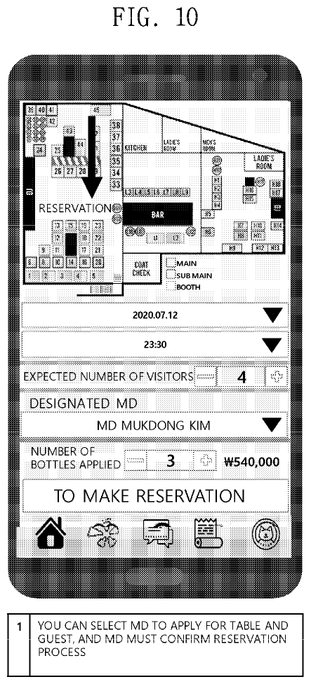

Let's explain it with a more specific example as follows. FIGS. 5 to 8 are user terminal output screens for general reservation, and FIGS. 9 and 10 are output screens of the user terminal for auction reservation.

1. General Reservation: After selecting adult establishment, a list of service managers is provided, and after selecting a specific service manager, it goes to the reservation screen.

2. Auction: The auction may be activated by the auction function by selecting a specific table.

1) Same-day auction: When the auction is held on the same day, it is possible to bid by amount, and the highest bid is selected when the bidding end time set by the owner is reached, and the winning bid will be selected immediately when an immediate successful bid is bid before that.

2) Auction a few days ago: The auction is possible from several days before the owner's authority, and the highest bid is awarded at the end of the bidding time.

3. Waiting: When the table is full, a pop-up window will appear and you will automatically go to the waiting alarm request. When an empty table appears, a notification is sent to all waiting people, and depending on the table setting, you may make a general reservation or an auction reservation.

When a table reservation request is input from the user terminal, the table arrangement information providing unit 130 provides table arrangement information of an adult establishment to the user terminal, and when the table is selected by the user terminal, the table price information providing unit 140 provides price information on the selected table to the user terminal.

The reservation information providing unit 150 transmits the determined reservation information to the terminal of the service manager when the reservation for the table is determined by the user terminal, and the reservation setting unit 160 sets a reservation for the table when there is an approval input from the service manager terminal.

Since managers (service managers) receive reservations from an adult establishment and handle customers' claims by managing customers on a one-to-one basis, the role of managers is essential, so that the managers must have access to reservation management privileges.

According to the present invention, even for an adult establishment such as a nightclub where the price of table arrangement and service is variable, it is possible to easily grasp information such as various current table layouts or table prices of an adult establishment, so that reservations may be made more easily and effectively.

The table arrangement information providing unit 130 includes an image drawing providing unit 132 that provides an image drawing of an adult establishment in which the table arrangement status is shown to a user terminal, and an activation drawing providing unit 134 that provides a drawing in which when a partial area of the image drawing is selected from the user terminal, the partial area is enlarged and the table select function is activated, and the image drawing providing unit 132 may provide by displaying the selected table on the image drawing when the table is selected through the activated drawing.

According to this configuration, even when using a mobile terminal with a small screen, it is possible to easily understand the entire table arrangement or reservation status of an adult establishment, and it is possible to prevent touch errors by using the enlarged screen when entering an actual reservation.

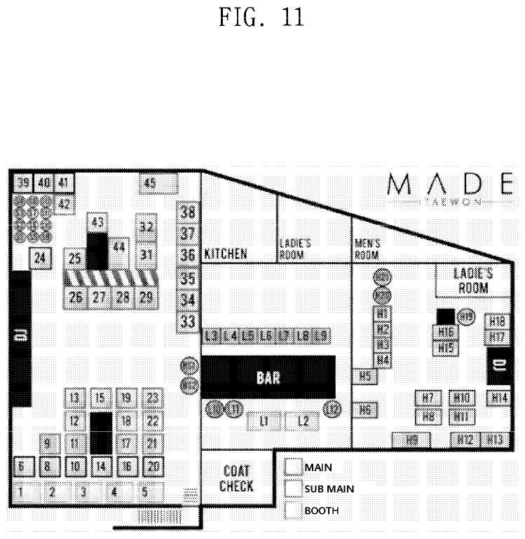

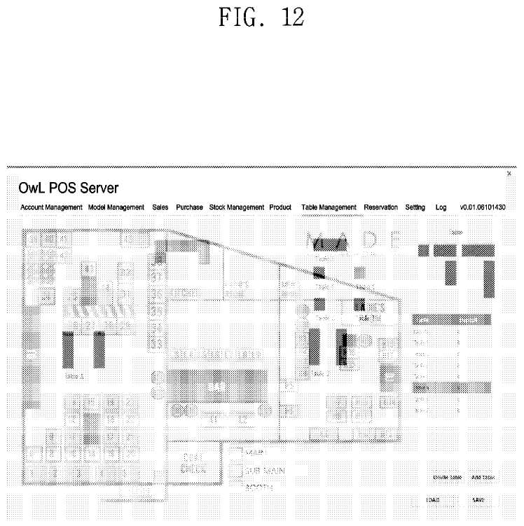

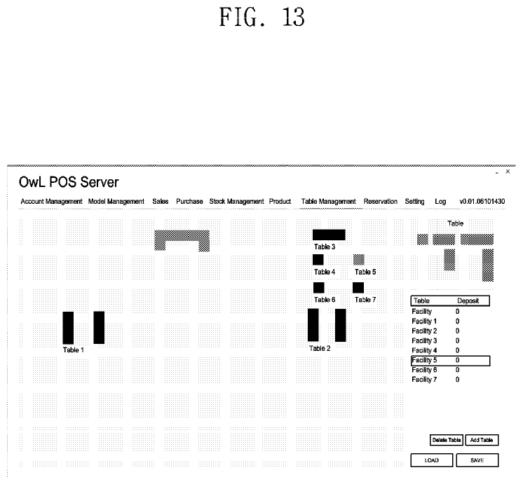

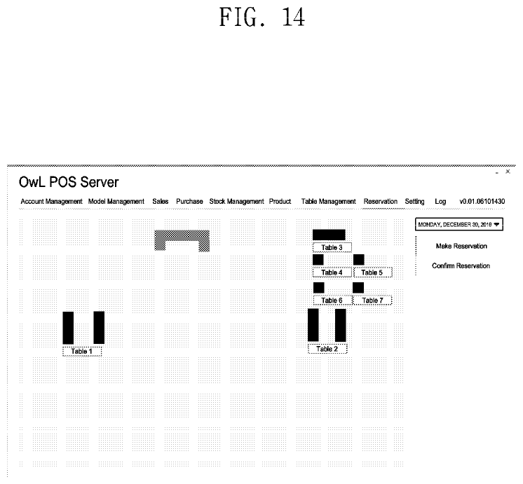

To this end, the owner uploads a bird's eye view of his adult establishment to the Internet, and puts a layer on top of the image so that all tables may be managed at a glance. However, for each adult establishment, there is an adult establishment that is divided into 1st and 2nd floors, or there is an adult establishment made with A zone B zone, and the like. Therefore, multiple bird's-eye views may be uploaded and managed through the tab function. The reservation status made in this way is then accessed by users, managers, etc. to use the reservation function. FIGS. 11 to 14 are diagrams illustrating an example of an adult establishment owner uploading a bird's eye view of their adult establishment and arranging a table layout.

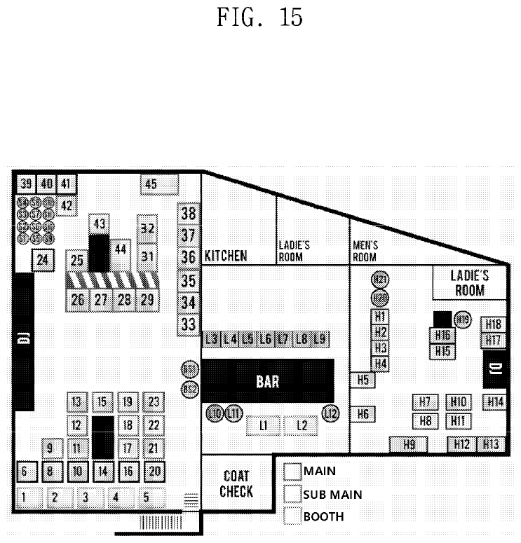

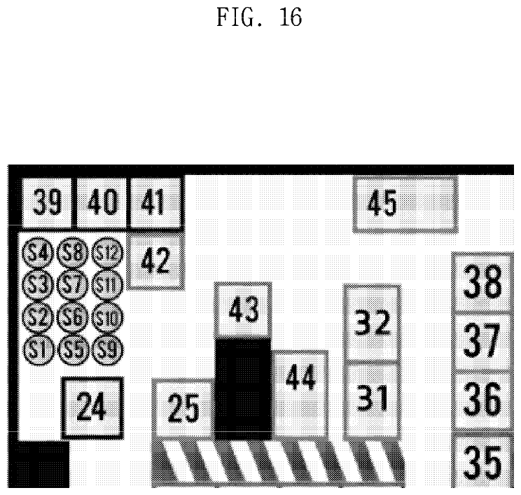

If checking a bird's eye view of the store for reservations in the app, an ‘image’ showing the current status of each table is uploaded and displayed. The image in the current state is called a ‘small bird's eye view’, and it is impossible to click the table. This ‘small bird's eye view’ is refreshed after the data is updated and imaged whenever the state of the table changes. (Refresh request whenever table data is changed) FIGS. 15 and 16 are diagrams showing examples of small and large bird's-eye views, respectively.

When double-clicking the ‘small bird's eye view’ in the app, it is enlarged to the same size as the size shown on the web bird's eye view editing page, which is called a ‘large bird's eye view’. In the ‘large bird's eye view’, the object is activated for each table rather than an image, and in the current state, it is possible to select and reserve by touching the table. In the ‘large bird's eye view’ state, it is possible to further enlarge the bird's eye view. When double-clicking on ‘large bird's eye view’, it changes back to ‘small bird's eye view’.

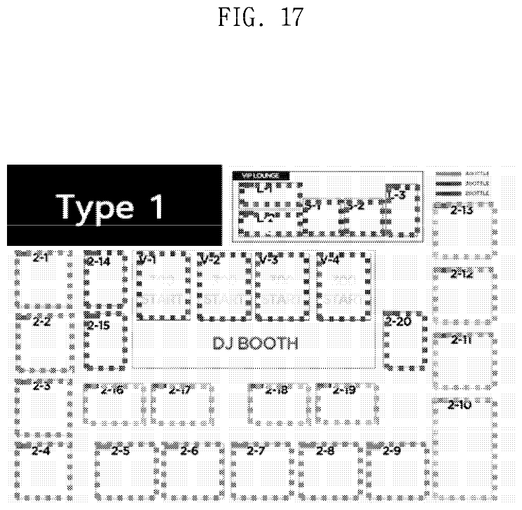

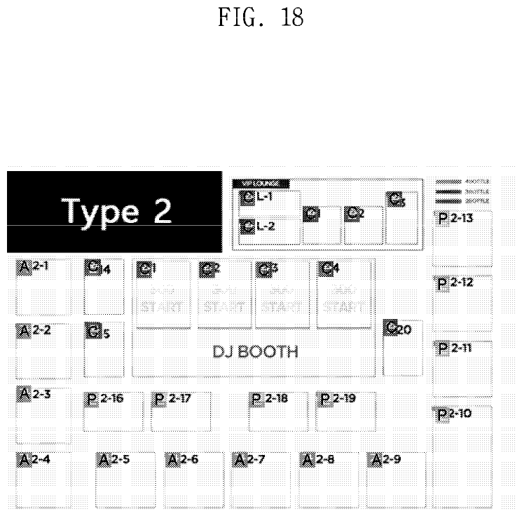

At this time, in the activated drawing, a tab that performs a table select input function may be arranged on the image of the table in the same size as the corresponding table, and may be arranged on the table images corresponding to each other in the same size. FIGS. 17 and 18 are diagrams respectively illustrating different examples in which a table select input function tab is disposed on a table of a bird's eye view.

FIG. 17 shows an example in which the table select input function tabs of different colors are overlapped with the same size as the corresponding table, and FIG. 18 shows an example in which different tables are arranged in a portion of a table with the same size regardless of the table size.

The table price information storage unit 170 stores the price information set in advance for the entire adult establishment table. According to this configuration, by using the overall price configuration preset for each situation such as weekdays, weekends, Christmas, etc., it is possible to easily apply an appropriate table price according to the situation.

In this case, the stored price is generally a price set in advance by an administrator or the like, but may be a price that was actually reserved and applied in the past.

When the clearing request transmission unit 180 receives a table emptying request from the terminal of the service manager, it transmits the received table emptying request to the terminal of the preset table manager, and the reservation-state change request input unit 190 receives a reservation update request for the table from the table manager terminal, and the reservation-state change unit 195 changes the reservation state for the table and displays the reservation-possible state for the image drawing.

According to this configuration, when the use of the table is finished, it is possible to effectively update the reservation condition for the next use and update the table reservation status.

Although the present invention has been described with reference to some preferred embodiments, the scope of the present invention should not be limited thereto, but should also extend to modifications or improvements of the above embodiments supported by the claims.

1. An adult establishment reservation service providing system comprising:
a table arrangement information providing unit configured to provide table arrangement information of adult establishment to a user terminal;
a table price information providing unit configured to provide price information on the selected table to the user terminal when a table is selected by the user terminal;
a reservation information providing unit configured to transmit the determined reservation information to the terminal of a service manager when the reservation for the table is determined by the user terminal; and
a reservation setting unit configured to set a reservation for the table when there is an approval input from the service manager terminal,
wherein the price information further comprises a current bid for the table.

2. The adult establishment reservation service providing system of claim 1, wherein the price information comprises price information preset for the table.

3. The adult establishment reservation service providing system of claim 2, wherein the price information further comprises an immediate successful bid price for the table.

4. The adult establishment reservation service providing system of claim 3, further comprising a table price storage unit configured to store the price information set in advance for the whole in the adult establishment table.

5. The adult establishment reservation service providing system of claim 4, further comprising:
a clearing request transmission unit configured to transmit a table emptying request to a preset table manager terminal when the table emptying request is input from the terminal of the service manager;
a reservation-state change request input unit configured to receive a reservation update request for the table from the table manager terminal; and
a reservation-state change unit configured to change the reservation status for the table, and display a reservation availability status for the image drawing.

6. A method of providing an adult establishment reservation service, the method comprising:
a table arrangement information providing operation of providing table arrangement information of adult establishment to a user terminal;
a table price information providing operation of providing price information on the selected table to the user terminal when a table is selected by the user terminal;
a reservation information providing operation of transmitting the determined reservation information to the terminal of a service manager when the reservation for the table is determined by the user terminal; and
a reservation setting operation of setting a reservation for the table when there is an approval input from the service manager terminal,
wherein the price information further comprises a current bid for the table.

7. A recording medium in which computer-readable program for executing the method of claim 6.
